(19) United States
(12) Patent Application Publication
(10) Pub. No.: US 2024/0067075 A1
(43) Pub. Date: Feb. 29, 2024

(54) MOUNTING AND MOVING MEDICAL EQUIPMENT IN A VEHICLE

(71) Applicant: Absolute Health & Performance, Inc., Austin, TX (US)

(72) Inventor: Roy Ruijia Shi, Austin, TX (US)

(21) Appl. No.: 17/822,502

(22) Filed: Aug. 26, 2022

(51) Int. Cl. B60P 7/08; A61G 3/00

(52) U.S. Cl. CPC B60P 7/0815; A61G 3/006

(57) ABSTRACT

A system and method of using, a mounting system for large medical equipment. The system can include a sled assembly and a pair of spaced parallel rails. The pair of rails can be mounted to the floor of a vehicle. The sled assembly can be coupled to the pair of rails and operable to move horizontally parallel to the longitudinal axis of the pair of rails. Large medical equipment can be coupled to the sled assembly allowing movement of the medical equipment.

### FIELD OF THE DISCLOSURE

The present disclosure generally relates to mobile medical services, and more particularly to mobile medical services that use large medical equipment transported in a vehicle to a patient location.

### BACKGROUND

Large medical equipment (e.g., a full body scanning device) have a large footprint, such as 8 feet by 4 feet. The large medical equipment can be mounted inside a vehicle to transport the medical equipment to a patient's location and to provide mobile medical services to a patient. For example, a vehicle containing a full-body scanner can drive to a location of a patient and perform the body scan at the patient's location.

The large medical equipment is usually permanently secured to the floor of the vehicle. The large medical equipment cannot be moved once secured. Moreover, the secured medical equipment is difficult to service, maintain, and repair once installed inside the vehicle. For example, in the case of a full body scanning device, many components are included in an area of the equipment that is below the surface where the patient lies for the scan. Accessing this area for service, maintenance, and repair in a vehicle is challenging.

Service is important to be able to maintain the long-term viability and usefulness of said equipment; thus, there is a need to reduce the difficulty in accessing, servicing, maintaining, and repairing large medical equipment that is mounted in a vehicle for mobile medical service.

### SUMMARY

A method can include horizontally moving a sled assembly on a pair of rails from a first position on the pair of rails to a second position on the pair of rails, wherein a first rail of the pair of rails is parallel to a second rail of the pair of rails, wherein each of the pair of rails is coupled to a floor of a vehicle; wherein the sled assembly can include a first foot configured to slide horizontally on a top surface of the first rail and coupled to a bottom of the large medical equipment, a second foot configured to slide horizontally on a top surface of the second rail to a bottom of the large medical equipment, and a cross member having an end coupled to the first foot and an opposite end coupled to the second foot.

A mounting system can include a first rail coupled to the chassis of the vehicle; a second rail coupled to the chassis of the vehicle, wherein the second rail is spaced apart from and parallel to the first rail; a sled assembly, that can include a first foot placed on a top surface of the first rail, a second foot placed on a top surface of the second rail, and a cross member having an end connected to the first foot and an opposite end connected to the second foot; a first guide member having a top portion coupled to a side of the first foot and a bottom portion in slidable contact with a side of the first rail; and a second guide member having a top portion coupled to a side of the second foot and a bottom portion in slidable contact with a side of the second rail.

Another method, for installing a medical equipment mounting system in a vehicle, can include cutting a hole in a top surface of each of a pair of rails, rounding sharp edges that are formed where the hole meets channels of each of the pair of rails to form rounded edges, inserting connection members through the hole in each of the pair of rails, inserting connection members through another hole formed in a bottom of each of the pair of rails, and securing the connection members to the vehicle. The method can also include placing one or more friction pads on the top surface of each of the pair of rails, placing a first foot and a second foot of a sled assembly on the one or more friction pads, coupling a first guide member to a first rail of the pair of rails and to the first foot, coupling a second guide member to a second rail of the pair of rails and to the second foot, coupling a first brake member to the first rail and to the first foot, and coupling a second brake member to the second rail and to the second foot. The method can also include placing a medical equipment on a top of the first foot and the second foot, and attaching the first foot and the second foot to the medical equipment.

Other technical features may be readily apparent to one skilled in the art from the following figures, descriptions and claims.

### BRIEF DESCRIPTION OF THE DRAWINGS

For a more complete understanding of this disclosure, reference is now made to the following description, taken in conjunction with the accompanying drawings, in which:

FIG. 1 illustrates a perspective view of a mounting system.

FIG. 2 illustrates a cross-sectional view of a rail that can be used in the disclosed mounting system and method.

FIG. 3 illustrates an end elevational view of the mounting system of FIG. 1.

FIG. 4A illustrates a side view of an embodiment of a guide member.

FIG. 4B illustrates a front view of the guide member of FIG. 4A.

FIG. 4C illustrates a side view of another embodiment of a guide member.

FIG. 4D illustrates a front view of the guide member of FIG. 4C.

FIG. 5A illustrates an end view of the mounting system of FIG. 1 and FIG. 3, with medical equipment attached thereto.

FIG. 5B illustrates a side elevational view of the mounting system and medical equipment of FIG. 5A.

FIG. 6 depicts a side view of medical equipment on a mounting system in a first position inside of a vehicle; and

FIG. 7 depicts a side view of the medical equipment on a mounting system of FIG. 6, horizontally moved to a second position.

FIGS. 8A, 8B, and 8C illustrate a top view of a rail in various steps for cutting a hole in the top surface of the rail.

### DETAILED DESCRIPTION

The term “coupled” as used herein refers to a direction connection between the components that are coupled, or alternatively, an indirect connection between the components that are coupled. An indirect connection may include other components positioned between the components that are described or claimed as being coupled.

The term “friction pad” and its derivatives as used herein refers to a material that reduces friction when used between two surfaces of the mounting system disclosed herein, compared to the amount of friction that would be present between the two surfaces without use of the friction pads. Friction pads are described in further detail herein.

Disclosed is a mounting system for movably securing medical equipment to the floor or bed of a vehicle and a method for moving the medical equipment in a vehicle using the mounting system. The mounting system and method allow for sliding the medical equipment, for example, for inspection and maintenance of components that are located on the bottom of the medical equipment and under a patient bed of the medical equipment. The mounting system eliminates the need to lift the medical equipment prior to moving the medical equipment, and allows for a much more ergonomic method to slide the medical equipment back and forth in a vehicle, making it easier for operators and technicians to move, inspect, and maintain the equipment.

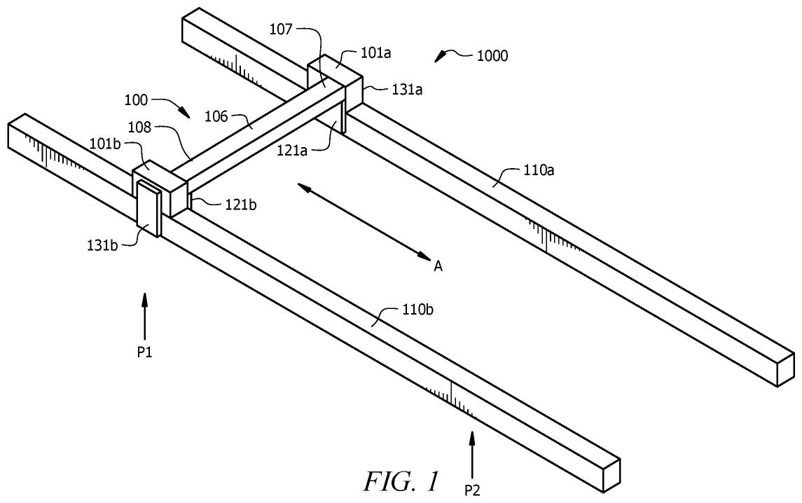

FIG. 1 illustrates a perspective view of a mounting system 1000. The mounting system can include a first rail 110a, a second rail 110b, a sled assembly 100 coupled to the first rail 110a and to the second rail 110b, a first guide member 121a coupled to the sled assembly 100, a second guide member 121b coupled to the sled assembly 100, a first brake member 131a coupled to the sled assembly 100, and a second brake member 131b coupled to the sled assembly 100.

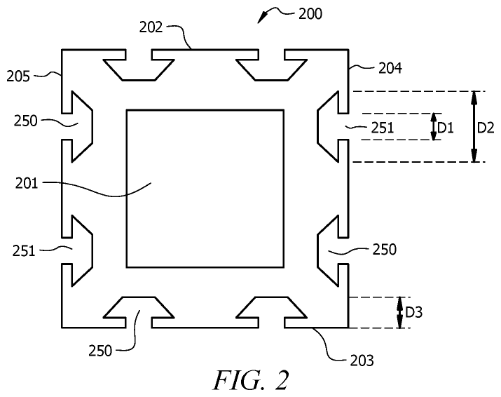

The first rail 110a and the second rail 110b can each be coupled to a vehicle, for example, to the floor or to the chassis of a vehicle. The second rail 110b can be spaced apart from and parallel to the first rail 110a. Each of the rails 110a, 110b can contain channel(s) 50 on any of the four surfaces, where each of the channel(s) 50 runs longitudinally along the length of each rail 110a, 110b. The channels 50 will be discussed in further detail in FIG. 2.

The sled assembly 100 can include a first foot 101a coupled to the first rail 110a, a second foot 101b coupled to the second rail 110b, and a cross member 106 connected to the first foot 101a and to the second foot 101b. In aspects, the cross member 106 of the sled assembly 100 can have an end 107 connected to the first foot 101a and an opposite end 108 connected to the second foot 101b. The sled assembly 100 can be configured to move between a first position P1 on the first and second rails 110a, 110b to a second position P2 on the first and second rails 110a, 110b, respectively. That is, the first foot 101a of the sled assembly 110 can be configured to move on the first rail 110a and the second foot 101b of the sled assembly 110 can be configured to move on the second rail 110b, where a movement of the first foot 101a is simultaneous with and in the same direction as a movement of the second foot 101b.

The first guide member 121a can be coupled to the first foot 101a and to the first rail 110a, and the second guide member 121b can be coupled to the second foot 101b and to the second rail 110b. The first guide member 121a can be configured to guide a movement of the first foot 101a (e.g., in a direction shown by double headed arrow A that is parallel to the longitudinal axis of the first rail 110a). The second guide member 121b can be configured to guide a simultaneous movement of the second foot 101b in a same direction as the first guide member 121a.

The first brake member 131a can be coupled to the first foot 101a and to the first rail 110a, and the second brake member 131b can be coupled to the second foot 101b and to the second rail 110b. The first brake member 131a can be configured to secure the first foot 101a into a fixed position on the first rail 110a so that it does not move to a different position on the first rail 110a. The second brake member 131b can be configured to secure the second foot 101b into a corresponding position on the second rail 110b so that it does not move to a different position on the second rail 110b.

FIG. 2 illustrates a cross-sectional view of a rail 200, such as the first rail 110a and the second rail 110b of FIG. 1 used in a disclosed mounting system 1000 and method. The rail 200 can be embodied as a metal tube, such as a rectangular tube. The rail 200 can be manufactured of any other material such as a strong plastic. In aspects, the rail 200 can include a hollow interior 201; alternatively, the rail 200 can have a solid interior 201. In aspects, the rail 200 can have channel(s) 250 formed in each of the surfaces 202, 203, 204, and 205 of the rail 200. Each of the top surface 202, bottom surface 203, first side surface 204, and second side surface 205 of the rail 200 in FIG. 2 includes two channels 250 that span the entire length of the rail 200. In alternative aspects, one or more of surfaces 202, 203, 204, and 205 can include one or more channels 250 while other of the surfaces 202, 203, 204, and 205 can include a different number of channels 250.

The cross-sectional shape of each channel 250 illustrated in FIG. 2 is trapezoidal; however, it is contemplated that the cross-section shape of the channels 250 can be any cross-sectional shape such as rectangular, square, triangular, ovular, circular, or combinations thereof.

Each surface 202, 203, 204, and 205 can have an opening 251 for each channel 250, through which or into which connection members disclosed herein or parts of reduced-friction pads can extend. Each opening 251 can have a diameter D1 that is less than a diameter or diagonal D2 of the respective channel 250. Each channel 250 can have a depth D3 as measured from the respective outer surface 202, 203, 204, and 205 in a range of 0.5 to 2 cm; alternatively, 0.5 cm to 1 cm. The difference in diameters D1 and D2 can serve to keep connection members of other parts, like the guide members 121a, 121b, and the brake members 131a, 131b, coupled to the rail 200 and can prevent erroneous lateral movement that is perpendicular to the longitudinal axis of the rail 200.

The channels 250 can function to guide the foot 101a and foot 101b of the sled assembly 100 along the rail 200 when the sled assembly 100 is moved along the rail 200; prevent lateral movement of the sled assembly 100 in a direction perpendicular to the longitudinal axis of the rail 200; secure the first foot 101a and the second foot 101b of the sled assembly 100 to each rail 200, or combinations thereof.

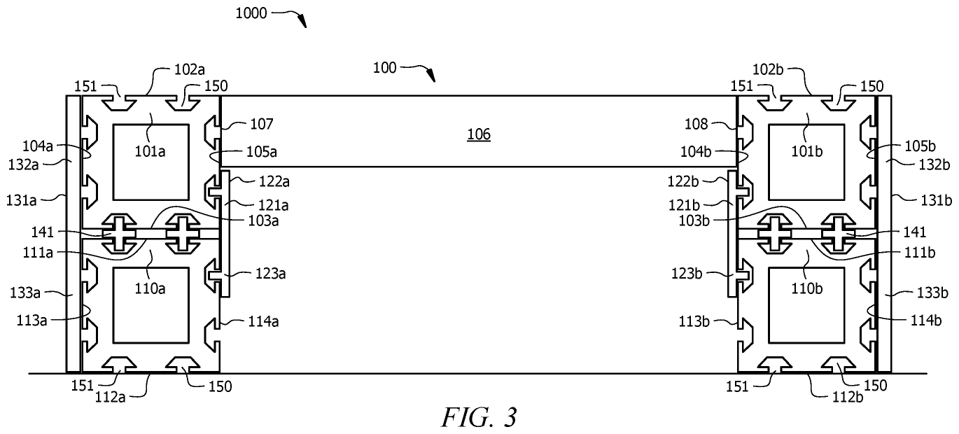

FIG. 3 illustrates an end elevational view of the mounting system 1000 in FIG. 1. It can be seen that first foot 101a, second foot 101b, first rail 110a, and second rail 110b have the same cross-sectional configuration as the rail 200 described in FIG. 2. The first foot 101a has a top surface 102a, bottom surface 103a, side surface 104a, and opposite side surface 105a. The second foot 101b has a top surface 102b, bottom surface 103b, side surface 104b, and opposite side surface 105b. The first rail 110a has a top surface 111a, a bottom surface 112a, a side surface 113a, and an opposite side surface 114a. The second rail 110b has a top surface 111b, a bottom surface 112b, a side surface 113b, and an opposite side surface 114b. While not shown in FIG. 3, medical equipment can be place on and connect to (e.g., with nuts and bolts) the top surface 102a of the first foot 101a and the top surface 102b of the second foot 101b.

FIG. 3 illustrates an end elevational view of the mounting system 1000, showing the interconnection of the rails 110a, 110b, the first foot 101a and the second foot 101b of the sled assembly 100; the guide members 121a, 121b; and the brake members 131a, 131b.

Regarding the sled assembly 100, in aspects, the end 107 of the cross member 106 can be connected (e.g., via nut and bolt) to a channel 150 of the first foot 101a via the side surface 105a of the first foot 101a that faces the cross member 106, and the opposite end 108 of the cross member 106 can be connected (e.g., via nut and bolt) to a channel 150 of the second foot 101b via the side surface 104b of the second foot 101b that faces the cross member 106. The cross member 106 can keep the first foot 101a and the second foot 101b spaced apart for a distance equal to the distance at which the rails 110a and 110b are spaced apart. Additionally, the cross member 106 can also distribute the weight of the medical equipment evenly on both the first foot 101a and the second foot 101b. Additionally, in some aspects, the cross member 106 can be attached to (e.g., via nuts and bolts) the bottom of the medical equipment.

Regarding connection of the sled assembly 100 to the rails 110a and 110b, the bottom surface 103a of the first foot 101a can be placed above a top surface 111a of the first rail 110a such that the openings 151 to channels 150 in the bottom surface 103a of the first foot 101a are aligned with the openings 151 to channels 150 in the top surface 111a of the first rail 110a. The bottom surface 103b of the second foot 101b can be above a top surface 111b of the second rail 110b such that the openings 151 to channels 150 in the bottom surface 103b of the second foot 101b are aligned with the openings 151 to channels 150 in the top surface 111b of the second rail 110b. In aspects, the number of channels 150 formed in the bottom surface 103a of the first foot 101a equals the number of channels 150 formed in the top surface 111a of the first rail 110a, and the number of channels 150 formed in the bottom surface 103b of the second foot 101b equals the number of channels 150 formed in the top surface 111b of the second rail 110b.

A friction pad 141 can be placed between corresponding channels 150 of the first foot 101a and the first rail 110a, and between the corresponding channels 150 of the second foot 101b and the second rail 110b. Each friction pad 141 can be manufactured of a polymeric non-stick material. The cross-sectional shape of each friction pad 141 in FIG. 3 is a cross-shape or plus-sign shape; however, the cross-sectional shape of each friction pad 141 can be any shape that achieves the functionality described herein. In FIG. 3, it can be seen that a portion of each friction pad 141 extends into a corresponding channel 150 of foot 101a or 101b and a corresponding channel 150 of rail 110a or 110b. While two friction pads 141 are illustrated between the bottom surface 103a of the first foot 101a and the top surface 111a of the first rail 110a, the two friction pads 141 can be formed of a single piece of material. While two friction pads 141 are illustrated between the bottom surface 103b of the second foot 101b and the top surface 111b of the second rail 110b, the two friction pads 141 can be formed of a single piece of material.

In aspects, the friction pads 141 have a length corresponding to the length of the first foot 101a and the second foot 101b. In these aspects, the first foot 101a and corresponding friction pad 141, as well as the second foot 101b and corresponding friction pad 141, can slide along the top surfaces 111a and 111b of the first and second rails 110a and 110b. In alternative aspects, the friction pads 141 have a length corresponding to the length of the rails 110a and 110b. In these alternative aspects, the first foot 101a and the second foot 101b can slide along the top surfaces 111a, 111b of the first and second rails 110a and 110b via the friction pads 141 (where the friction pads 141 do not move relative to the rails 110a and 110b).

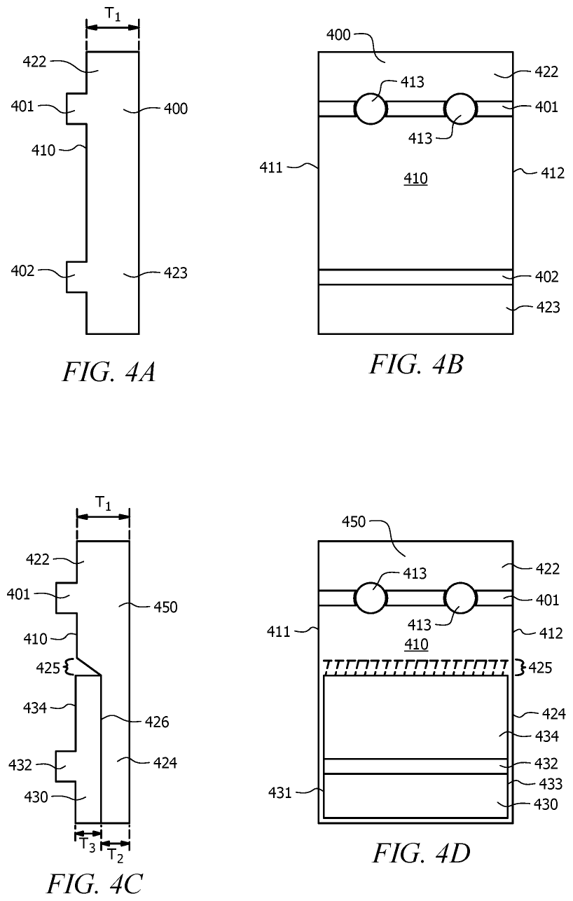

Regarding the first guide member 121a, a top portion 122a of the first guide member 121a can be coupled to a opposite side surface 105a of the first foot 101a. This connection can be achieved by inserting a protrusion (see FIGS. 4A and 4C and accompanying description of protrusions) of the top portion 122a of the first guide member 121a into a channel 150 via the opposite side surface 105a of the first foot 101a, and connecting the top portion 122a to the first foot 101a via a connection member that extends through the top portion 122a and into the channel 150 of the side surface 105a of the first foot 101a. A bottom portion 123a of the first guide member 121a can be coupled to side surface 114a of the first rail 110a. This connection can be achieved by inserting a protrusion (see FIGS. 4A and 4C and accompanying description of protrusions) of the bottom portion 123a of the first guide member 121a into a channel 150 via the opposite side surface 114a of the first rail 110a, where the bottom portion 123a is not connected or secured to the first rail 110a and the protrusion can guide movement of the sled assembly 100 as the protrusion moves in the channel 150 and in a direction that is parallel to the longitudinal axis of the first rail 110a.

Regarding the second guide member 121b, a top portion 122b of the second guide member 121b can be coupled to a side surface 104b of the second foot 101b. This connection can be achieved by inserting a protrusion (see FIGS. 4A and 4C and accompanying description of protrusions) of the top portion 122b of the second guide member 121b into a channel 150 via the side surface 104b of the second foot 101b, and connecting the top portion 122b to the second foot 101b via a connection member that extends through the top portion 122b and into the channel 150 of the side surface 104b of the second foot 101b. A bottom portion 123b of the second guide member 121b can be coupled to side surface 113b of the second rail 110b. This connection can be achieved by inserting a protrusion (see FIGS. 4A and 4C and accompanying description of protrusions) of the bottom portion 123b of the second guide member 121b into a channel 150 via the side surface 113b of the second rail 110b, where the bottom portion 123b is not connected or secured to the second rail 110b and the protrusion can guide movement of the sled assembly 100 as the protrusion moves in the channel 150 and in a direction that is parallel to the longitudinal axis of the second rail 110b.

Regarding the first brake member 131a, the first brake member 131a can have a top portion 132a and a bottom portion 133a. The top portion 132a can be coupled to the first foot 101a via side surface 104a by one or more connection members (e.g., one or more nut and bolt pair) that extends through the top portion 132a and into the channel 150 of the side surface 104a. The bottom portion 133a can be coupled to the first rail 110a via side surface 113a by one or more connection members (e.g., one or more nut and bolt pair) that extends through the bottom portion 133a and into the channel 150 of the side surface 113a.

Regarding the second brake member 131b, the second brake member 131b can have a top portion 132b and a bottom portion 133b. The top portion 132b can be coupled to the second foot 101b via opposite side surface 105b by one or more connection members (e.g., one or more nut and bolt pair) that extends through the top portion 132b and into the channel 150 of the opposite side surface 105b. The bottom portion 133b can be coupled to the opposite side surface 114b of the second rail 110b by one or more connection members (e.g., one or more nut and bolt pair) that extends through the bottom portion 133b and into the channel 150 of the opposite side surface 114b.

The connection members in combination with the brake members 131a and 131b can releasably secure the sled assembly 100 into a fixed position on the first rail 110a and the second rail 110b. The connection members coupled with the top portions 132a and 132b and the bottom portions 133a and 133b can be loosened when the large medical equipment is to be moved, and tightened again when the large medical equipment is to be secured. Each of the brake members 131a, 131b can have one or more bolts tightened to prevent the sled assembly 100 from moving along the rails 110a, 100b. When the bolts are tightened, the brake members 131a, 131b can be in a secured position and when the bolts are loose, the brake members 131a, 131b can be in an unsecured position.

FIG. 4A illustrates a side view of an embodiment of a guide member 400. The configuration of guide member 400 can be used as configuration for the first guide member 121a, the second guide member 121b, or both guide members 121a and 121b of the mounting system 1000. The guide member 400 has a top portion 422 and a bottom portion 423. The top portion 422 and the bottom portion 423 are integrally formed of the same material, such as a metal (e.g., steel, aluminum). The top portion 422 and the bottom portion 423 have the same thickness T1. In aspects, the thickness T1 can be in a range of about 0.5 to about 2 inches; alternatively, from about 0.75 to about 1.5 inches; alternatively, a thickness T1 of about 1 inch. Protrusion 401 extends from side 410 of the top portion 422, and protrusion 402 extends from side 410 of the bottom portion 423 of the guide member 400. The protrusions 401 and 402 are sized to fit in the openings of the respective channels (e.g., openings 151 of channels 150 in FIG. 3) of the foot and rail (e.g., first foot 101a and first rail 110a) to which the guide member 400 couples.

FIG. 4B illustrates a front view of the guide member 400 of FIG. 4A. It can be seen that protrusions 401 and 402 extend from end 411 to end 412 of the guide member 400. Holes 413 are formed in the guide member 400, where the center of each hole 413 intersects the center line of the protrusion 401 of the top portion 422. The holes 413 are configured to receive a connection member therethrough. In aspects, there are no holes formed in the bottom portion 423 since connection members are not used on the bottom portion 423 of the guide member 400.

FIG. 4C illustrates a side view of another embodiment of a guide member 450. The configuration of guide member 450 can be used as configuration for the first guide member 121a, the second guide member 121b, or both guide members 121a and 121b of the mounting system 1000. The guide member 450 has a top portion 422 and a bottom portion 424. The top portion 422 and the bottom portion 424 can be integrally formed of the same material, such as a metal (e.g., steel, aluminum). The top portion 422 has thickness T1, and the bottom portion 424 has thickness T2. A portion 425 of the bottom portion 424 can have a tapering thickness that tapers from thickness T1 to thickness T2; alternatively, the bottom portion 424 has a constant thickness T2. In aspects, the thickness T1 can be in a range of about 0.5 to about 2 inches; alternatively, from about 0.75 to about 1.5 inches; alternatively, a thickness T1 of about 1 inch. The thickness T2 can be in a range of about 0.1 to about 0.75 inch; alternatively, from about 0.25 to about 0.5 inch; alternatively, a thickness T2 of about 0.33 inch. The thickness T3 can be in a range of about 0.1 to about 0.75 inch; alternatively, from about 0.25 to about 0.5 inch; alternatively, a thickness T3 of about 0.33 inch.

Protrusion 401 extends from side 410 of the top portion 422. A friction pad 430 can be attached to the side 426 of the bottom portion 424. The friction pad can have a thickness T3 such that the sum of the thickness T3 of the friction pad 430 and the thickness T2 of the bottom portion 424 equals the thickness T1 of the top portion 422. The protrusion 432 extends from side 434 of the friction pad 430 of the guide member 450. The protrusions 401 and 432 are sized to fit in the openings of the respective channels (e.g., openings 151 of channels 150 in FIG. 3) of the foot and rail (e.g., first foot 101a and first rail 110a) to which the guide member 450 couples.

FIG. 4D illustrates a front view of the guide member of FIG. 4C. It can be seen that protrusion 401 extends from end 411 to end 412 of the guide member 400. Holes 413 are formed in the guide member 400, where the center of each hole 413 intersects the center line of the protrusion 401 of the top portion 422. The holes 413 are configured to receive a connection member therethrough. The protrusion 432 extends from end 431 to end 433 of the friction pad 430. In aspects, there are no holes formed in the bottom portion 424 or in the friction pad 430 since connection members are not used on the bottom portion 424 of the guide member 400.

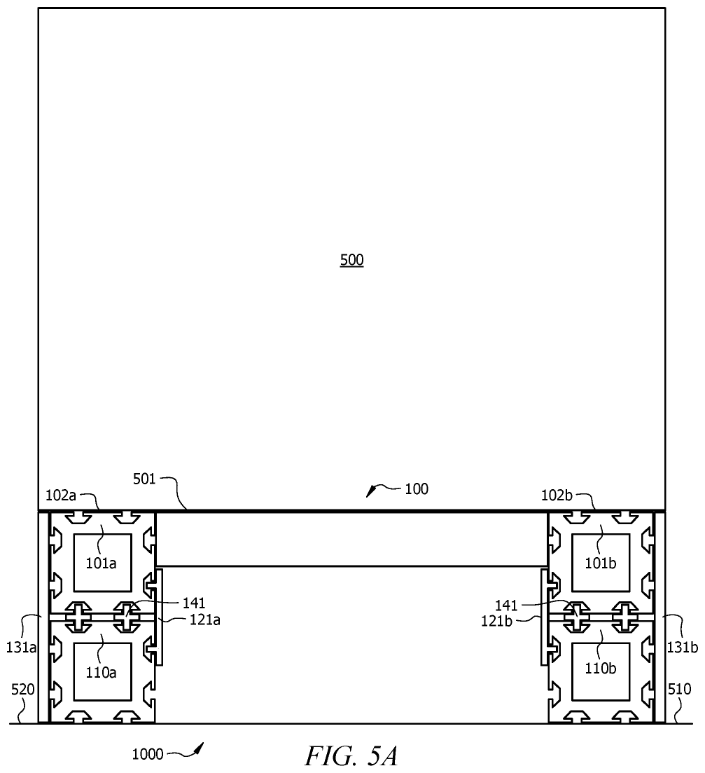

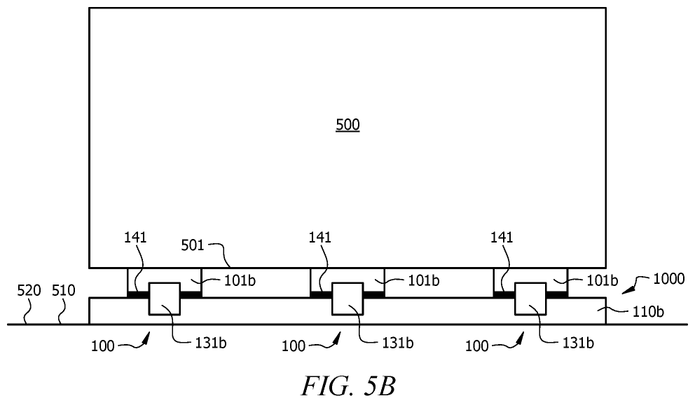

FIG. 5A illustrates an end view of the mounting system 1000 in FIG. 3 with a medical equipment 500 attached to the sled assembly 100. The mounting system 1000 is attached to the floor 510 of a vehicle 520. A bottom side 501 of the medical equipment 500 can be attached to a top surface 102a of the first foot 101a and a top surface 102b of the second foot 101b. The first foot 101a and the second foot 101b can be attached to a metal frame of the medical equipment 500, for example, using a bolt and nut, welds, or adhesive. Other attachment members can be used to attach the mounting system 1000 to the medical equipment 500 without departing from the present disclosure. The first rail 110a and the second rail 110b can be spaced apart at a distance which accommodate the width of the medical equipment 500.

FIG. 5B illustrates a side elevational view of the mounting system 1000 and medical equipment 500 of FIG. 5A. FIG. 5B demonstrates that the mounting system 1000 can include more than one sled assembly 100. FIG. 5B illustrates three sled assemblies 100. In the view of FIG. 5B, it can be seen that each sled assembly 100 has a second foot 101b above the second rail 110b, with a friction pad 141 between each second foot 101b and the rail 110b. Each sled assembly 100 can be attached to the bottom side 501 (e.g., a frame) of the medical equipment 500.

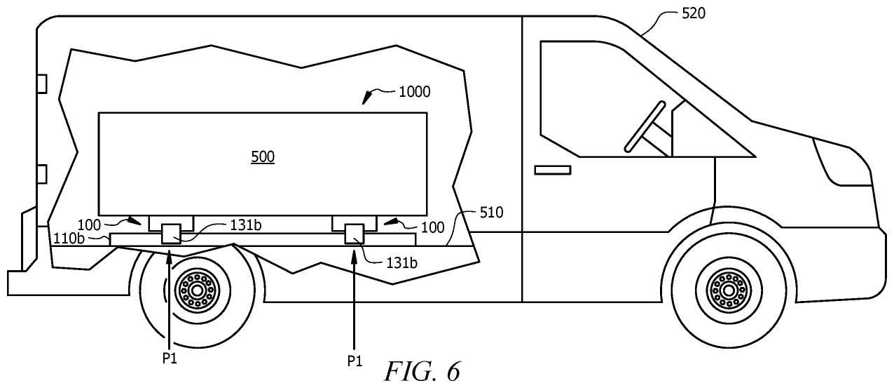

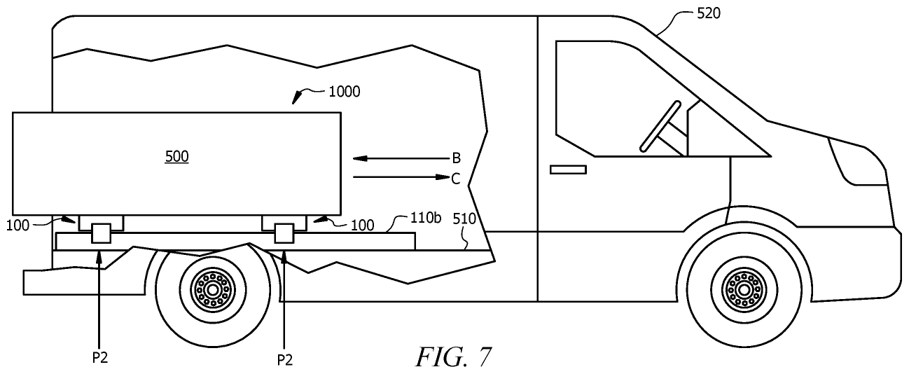

FIG. 6 depicts a side view of medical equipment 500 on a mounting system 1000 in a first position P1 inside of a vehicle 520, and FIG. 7 depicts a side view of the medical equipment 500 on the mounting system of FIG. 6, horizontally moved to a second position P2. The mounting system 1000 has two sled assemblies 100 to support and move the medical equipment 500. The mounting system 1000 can begin in a first position P1, wherein the medical equipment 500 is entirely inside of the vehicle 520 as depicted in FIG. 6. To move the medical equipment 500, the brake members 131b can be changed from the secured position to the unsecured position. The medical equipment 500 can then be moved horizontally in a first direction of arrow B to a second position P2. The brake members 131b can then be changed from the unsecured position to the secured position. In aspects, a portion of the medical equipment 500 can be outside the vehicle 520 when the mounting system 1000 is in the second position P2. The brake members 131b can then be changed to the unsecured position, and the medical equipment 500 can be horizontally moved in the direction of arrow C to the first position P1. When the medical equipment has returned to the first position P1, the brake members 131, 132 can be changed to the secured position.

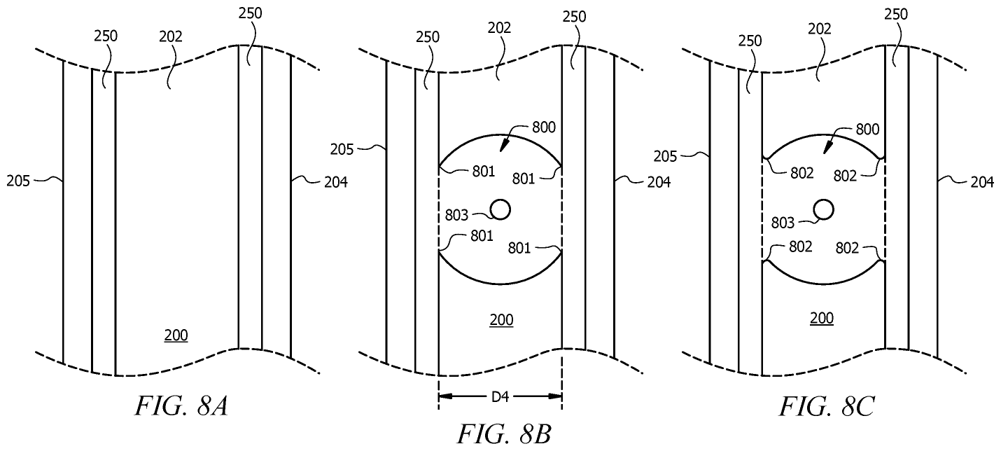

FIGS. 8A, 8B, and 8C illustrate a top view of a rail 200 in various steps for cutting a hole 800 in the top surface 202 of the rail 200, before securing the rail 200 to a vehicle.

FIG. 8A shows the rail 200 viewed from the top surface 202, and the channels 250 that are seen from the top surface 202, between the side surface 204 and the side surface 205. The view of rail 200 in FIG. 8A is before cutting a hole in the top surface 202.

FIG. 8B shows a hole 800 cut into the top surface 202 of the rail 200. The hole 800 is a circular hole having a diameter that is slightly greater than the distance D4 between the channels 250. Once the hole 800 is cut, the bottom of the interior of the rail 200 can be seen, and hole 803 can be seen formed therein, for inserting a connection member such as a bolt. The bolt can be inserted into hole 800 and then through hole 803 to secure the rail 200 to a vehicle as described herein. Cutting the hole 800 results in sharp edges 801 remaining where the edge of the hole 800 meets the channels 250.

For aspects that include friction pads 141 having a length that corresponds to the length of the foot 101a and 101b, and thus slide with the sled assembly 100 on the top surface 202 of the rail 200, it has been found that the useful life of the friction pads 141 is greatly reduced due to slashing of the friction pads 141 on the sharp edges 801. That is, the sharp edges 801 act like a knife or blade, cutting the friction pads 141 as the sled assembly 100 moves between positions on the rail 20, until the friction pads 141 fail.

FIG. 8C shows that the sharp edges 801 of FIG. 8B are converted into rounded edges 802. It has been found that rounding the sharp edges 801 into rounded edges 802 eliminates the cutting of the friction pads 141.

A method for moving the large medical equipment 500 in a vehicle 520, can include horizontally moving a sled assembly 100 on a pair of rails 110a and 110b from a first position P1 on the pair of rails 110a and 110b to a second position P2 on the pair of rails 110a and 110b. The vehicle 520 can have a pair of rails 110a and 110b attached to the floor or chassis 510 of the vehicle 520. At least one sled assembly 100 can be coupled to the pair of rails 110a and 110b as described above. The medical equipment 500 can be coupled to the at least one sled assembly 100 as described above. During travel or storage, the sled assembly 100 can be locked in a first position P1, wherein the medical equipment 500 is fully enclosed in the vehicle 520. When in the first position P1, the brake members 131a and 131b of the sled assembly 100 can be locked in the secured position, holding the sled assembly 100 in the first position.

The sled assembly 100 can be horizontally moved from the first position to the second position. From the first position, the brake members 131a and 131b can be changed from the secured position to the unsecured position. After the brake members 131a and 131b are in the unsecured position, the sled assembly 100 can be moved in a first direction that is horizontal and parallel with the longitudinal axis of the pair of rails 110a and 110b. After the step of horizontally moving the sled assembly 100, the first and second brake members 131a and 131b can be changed from the unsecured position to the secured position. This ensures that the sled assembly 100, and therefore the medical equipment 500, does not move from either the first position or the second position. The sled assembly 100, and medical equipment 500, can also be moved from the second position to the first position.

During the step of horizontally moving, the method can further include guiding a first movement of the first foot 101a in the first direction A that is parallel to a longitudinal axis of the first rail 110a. The method can also include guiding a second movement of the second foot 101b in the first direction A that is parallel to a longitudinal axis of the second rail 110b. Guiding the sled assembly 100 in the first direction A can be performed by the first guide member 121a and the second guide member 121b configured as described herein.

In aspects, the sled assembly 100 can be moved to a second position P2, wherein a portion of the medical equipment 500 extends outside the vehicle 520. Once the sled assembly 100 is in the second position P2, the brake members 131a and 131b can be returned to the secured position.

The above method, or another method disclosed herein can include cutting hole 800 in a top surface 202 of a rail 200, and rounding the sharp edges 801 that are formed where the hole 800 meets the channels 250 of the rail 200 to form rounded edges 802. The above method, or another method disclosed herein can additionally include inserting a connection member through the hole 800 and into the interior of the rail 200, and through another hole 803 formed in a bottom of the rail 200, and securing the connection member to a vehicle. Holes can be cut for any number of rails in a mounting system, and any number of holes can be cut, and edges rounded, so as to adequately secure the rail(s) to the vehicle.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method for horizontally moving a large medical equipment in a vehicle, the method comprising:
horizontally moving a sled assembly on a pair of rails from a first position on the pair of rails to a second position on the pair of rails, wherein a first rail of the pair of rails is parallel to a second rail of the pair of rails, wherein each of the pair of rails is coupled to a floor of the vehicle;
wherein the sled assembly comprises:
a first foot configured to slide horizontally on a top surface of the first rail and coupled to a bottom of the large medical equipment,
a second foot configured to slide horizontally on a top surface of the second rail and coupled to a bottom of the large medical equipment, and
a cross member having an end coupled to the first foot and an opposite end coupled to the second foot.

2. The method of claim 1, further comprising:
horizontally moving the sled assembly on the pair of rails from the second position to the first position.

3. The method of claim 1, wherein the large medical equipment is enclosed within the vehicle in the first position, wherein at least a portion of the large medical equipment extends outside the vehicle in the second position.

4. The method of claim 1, further comprising:
prior to the step of horizontally moving, changing each of a first brake member and a second brake member from a secured position to an unsecured position,
wherein the first brake member has a top portion coupled to a side of the first foot and a bottom portion coupled to a side of the first rail; and
wherein the second brake member has a top portion coupled to a side of the second foot and a bottom portion coupled to a side of the second rail.

5. The method of claim 4, further comprising:
after the step of horizontally moving, changing each of a first brake member and a second brake member from the unsecured position to the secured position.

6. The method of claim 1, further comprising:
during the step of horizontally moving, guiding a first movement of the first foot in a first direction that is parallel to a longitudinal axis of the first rail; and
during the step of horizontally moving, guiding a second movement of the second foot in a second direction that is parallel to a longitudinal axis of the second rail.

7. The method of claim 6, wherein guiding a first movement is performed by a first guide member having a top portion coupled to a side of the first foot and a bottom portion in slidable contact with a side of the first rail; and wherein guiding a second movement is performed by a second guide member having a top portion coupled to a side of the second foot and a bottom portion in slidable contact with a side of the second rail.

8. The method of claim 7, wherein the bottom portion of the first guide member has a protrusion that extends into a channel formed on the side of the first rail.

9. The method of claim 8, wherein the bottom portion of the second guide member has a protrusion that extends into a channel formed on the side of the second rail.

10. The method of claim 9, wherein the top portion of the first guide member has a protrusion that extends into the channel formed on the side of the first rail, and wherein the top portion of the second guide member has a protrusion that extends into the channel formed on the side of the second rail.

11. A mounting system for mounting large (medical) equipment on a floor or bed of a vehicle, comprising:
a first rail coupled to the vehicle;
a second rail coupled to the vehicle, wherein the second rail is spaced apart from and parallel to the first rail;
a sled assembly comprising:
a first foot placed on a top surface of the first rail,
a second foot placed on a top surface of the second rail,
a cross member having an end connected to the first foot and an opposite end connected to the second foot;
a first guide member having a top portion coupled to a side of the first foot and a bottom portion in slidable contact with a side of the first rail; and
a second guide member having a top portion coupled to a side of the second foot and a bottom portion in slidable contact with a side of the second rail.

12. The mounting system of claim 11, wherein the first foot is configured to slide along the top surface of the first rail, wherein the second foot is configured to slide along the top surface of the second rail.

13. The mounting system of claim 11, wherein the first guide member is configured to guide a first movement of the first foot in a first direction that is parallel to a longitudinal axis of the first rail, wherein the second guide member is configured to guide a second movement of the second foot in a second direction that is parallel to a longitudinal axis of the second rail.

14. The mounting system of claim 13, wherein the bottom portion of the first guide member is coupled with the side of the first rail, wherein the bottom portion of the second guide member is coupled with the side of the second rail.

15. The mounting system of claim 14, wherein the bottom portion of the first guide member has an attachment that is received in a channel of the side of the first rail, wherein the bottom portion of the second guide member has an attachment that is received in a channel of the side of the first rail.

16. The mounting system of claim 14, wherein the first guide member further has a first pad on the side of the first guide member, wherein the second guide member has a second pad on the side of the second guide member.

17. The mounting system of claim 11, further comprising
a first brake member having a top portion coupled to an opposite side of the first foot and a bottom portion coupled to an opposite side of the first rail; and
a second brake member having a top portion coupled to an opposite side of the second foot and a bottom portion coupled to an opposite side of the second rail,
wherein the first brake member and the second brake member are configured to secure the first foot and second foot on the top surface of the first rail and the top surface of the second rail.

18. A method for installing a medical equipment mounting system in a vehicle, the method comprising:
cutting a hole in a top surface of each of a pair of rails;
rounding sharp edges that are formed where the hole meets channels of each of the pair of rails to form rounded edges;
inserting connection members through the hole in each of the pair of rails;
inserting connection members through another hole formed in a bottom of each of the pair of rails;
and securing the connection members to the vehicle.

19. The method of claim 18, further comprising:
placing one or more friction pads on the top surface of each of the pair of rails;
placing a first foot and a second foot of a sled assembly on the one or more friction pads;
coupling a first guide member to a first rail of the pair of rails and to the first foot;
coupling a second guide member to a second rail of the pair of rails and to the second foot;
coupling a first brake member to the first rail and to the first foot; and
coupling a second brake member to the second rail and to the second foot.

20. The method of claim 19, further comprising:
placing a medical equipment on a top of the first foot and the second foot; and
attaching the first foot and the second foot to the medical equipment.
